(19) United States
(12) Patent Application Publication
(10) Pub. No.: US 2009/0287561 A1
(43) Pub. Date: Nov. 19, 2009

(54) METHOD AND SYSTEM TO AVOID FAKE METRICS IN ADVERTISING

(75) Inventors: Michal Andrzej RYBAK, Prospect (BB); Gaelle MARTIN-COCHER, Toronto (CA)

Correspondence Address: RESEARCH IN MOTION;ATTN: GLENDA WOLFE, BUILDING 6, BRAZOS EAST, SUITE 100, 5000 RIVERSIDE DRIVE, IRVING, TX, 75039, US

(73) Assignee: RESEARCH IN MOTION LIMITED, Waterloo (CA)

(21) Appl. No.: 12/121,729

(22) Filed: May 15, 2008

(51) Int. Cl. G06Q 30/00

(52) U.S. Cl. 705/14.26

(57) ABSTRACT

A method and apparatus to avoid fake advertisement metrics from an untrusted application, the method receiving an indication from the untrusted application that an advertisement is required, assuming control of at least a portion of a user interface, providing the advertisement, compiling metrics; and reporting the compiled metrics.

### FIELD OF THE DISCLOSURE

The present disclosure relates to advertising and in particular to consumption metrics regarding advertising.

### BACKGROUND

On computer systems and mobile devices, advertisers generally pay for an advertisement by the number of times that it is consumed. Consumption as used herein means viewing, clicking on, utilizing or some other form of interaction with the ad that can be measured. Based on this, it is important to advertisers that the consumption of the ad be real, and not faked.

Faking could occur, for example, by having an application request advertisements for consumption by a user and returning metrics of consumption by the user without actually using the ads or displaying them to the user. This is merely one example.

Various computationally expensive techniques are provided on wired networks or on devices with significant computational power. These include treating the metric as accurate and then reviewing the source of the consumption. Thus, on a click through advertisement the statistics could be compiled as to who is clicking through and if a significant proportion of the click through comes from a single IP address, this could indicate fake metrics. Other examples would be known to those in the art.

Further, faking metrics is easier when embedding advertising into an application. Methods for detecting these fake metrics are not fool proof in many circumstances.

### SUMMARY

The present disclosure provides a method to avoid fake advertisement metrics from an untrusted application using a trusted advertising client, comprising: receiving at the trusted advertising client an indication from the untrusted application that an advertisement is required; assuming control by the trusted advertising client of at least a portion of a user interface; providing the advertisement; receiving and compiling metrics at the trusted advertising client; and reporting the compiled metrics.

The present disclosure further provides a device adapted to avoid fake advertisement metrics comprising: a processor; a communications subsystem; a user interface; at least one untrusted application running on said processor, said at least one untrusted application adapted to interact with said user interface; and a trusted advertising client, said trusted advertising client adapted to receive a request from the untrusted application for an advertisement, assume control over at least a portion of the user interface, provide the advertisement over the user interface, and compile advertisement metrics.

### BRIEF DESCRIPTION OF THE DRAWINGS

The present disclosure will be better understood with reference to the drawings in which:

FIG. 1 is a block diagram showing an exemplary advertising system;

FIG. 2 is a flow chart showing a process for displaying advertisements and receiving use metrics;

FIG. 3 is a data flow diagram showing communications between a user interface, application and advertising client; and

FIG. 4 is a block diagram of an exemplary mobile device apt to be used with the present disclosure.

### DETAILED DESCRIPTION

The present disclosure can be utilized in both wired and wireless environments. The use of wireless environments is used below for illustration purposes. However, this is not meant to be limiting and the present system and method could equally be utilized in a wired environment.

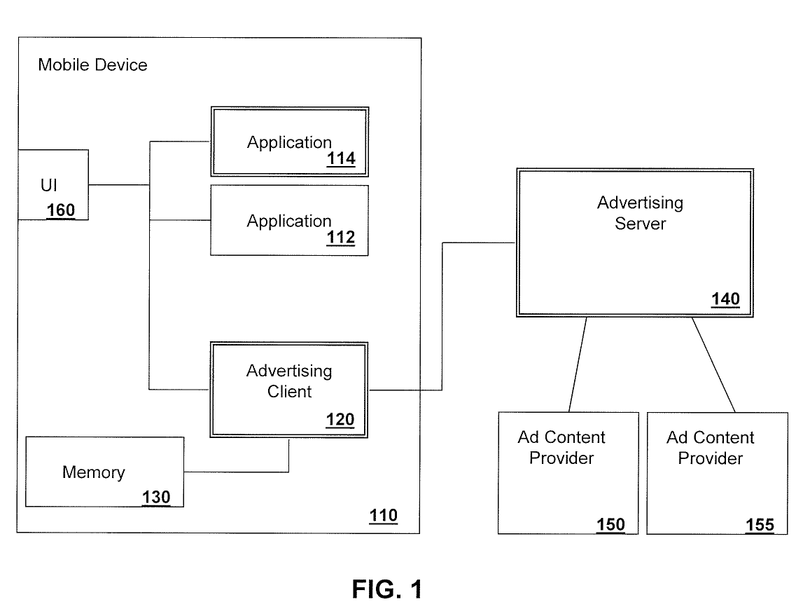

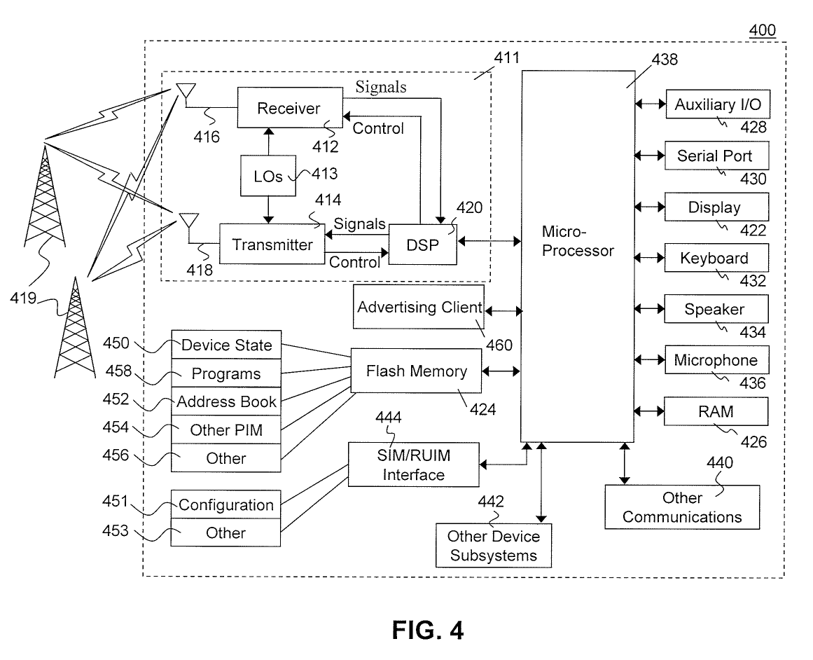

Reference is now made to FIG. 1. FIG. 1 shows a block diagram illustrating logical components within a system for facilitating mobile advertisement. A mobile device 110 is adapted to consume or create content through an application 112 and to perform other related functions, as would be known to those skilled in the art. When used herein, a mobile device is a general term that could include cellular telephones, mobile devices, pagers, laptop computers or other devices known to those skilled in the art. An exemplary mobile device is described below with reference FIG. 4.

In the embodiment of FIG. 1, mobile device 110 includes applications 112 and 114, and an advertising client 120.

The use of applications 112 and 114 are merely meant for simplification and in practice multiple applications would be on a mobile device 110.

Applications 112 and 114 represent applications that utilize advertisements. Examples could include an advertisement enabled email application in which advertisements are inserted into email messages, a web browser showing web pages into which advertisements can be inserted, instant messaging applications into which advertisements can be inserted, video or multimedia players which can have advertisements therein, or games, among others. This is not meant to limit applications 112 and 114, and any application could be utilized as long as it includes the ability to have advertisement.

In the embodiment of FIG. 1, an advertising client 120 communicates with applications 112 and 114, for example utilizing an application program interface (API), and can further communicate with an advertising server 140, for example through a communications subsystem on mobile device 110.

Advertising client 120 can further communicate with memory on a mobile device 110. Such memory is shown as memory 130 in FIG. 1. The communication can, for example, proceed through a processor and a bus.

Advertising server 140 is responsible for selecting or providing advertisements from registered advertising content providers to appropriate devices. In one embodiment, the advertising server 140 is also responsible for delivering advertisements to mobile device 110. As will be appreciated this can be done through a pull system in which an advertising client 120 requests ads from advertising server 140. Alternatively, this could be done on a push system in which advertising server 140 decides that mobile device 110 should have certain ads and pushes these ads to advertising client 120.

Further, advertisements can be pulled on the fly. In other words, the advertisements can be obtained from advertising server 140 as they are required by application 112 or 114. In alternative configurations the advertising server 140 could provide ads to mobile device 110 which are stored within memory 130 of the mobile device. This could facilitate the transfer of ads when network conditions are preferable for data transfer. Such network conditions could include a low cost period such as in the middle of the night or when the mobile device 110 is connected to a network through means such as a USB connection through a computer or through a wireless local area network (WLAN) such as WiFi.

A registered ad content provider, as illustrated by ad content providers 150 and 155 in FIG. 1, is an ad content provider with an established business relationship with advertising server 140.

In one embodiment, when new ad content providers such as ad content provider 150 registers with advertising server 140 it can provide information about types of advertisements that it is providing. This could enable advertising server 140 to target advertisements based on the user of mobile device 140. For example, mobile device 110 could include a profile that it provides to advertising server 140 regarding the preferences of a user of mobile device 110. As such, mobile advertising server 140 could, in this embodiment, match the user preferences.

In one embodiment, mobile device 110 includes a profile stored in memory 130. A profile could be created based on user questionnaires when the user first signs up to use the mobile device or could be based on some sort of watching application which tracks the user's content consumption and creation to build a profile.

Under a traditional model of mobile advertising, mobile advertising server 140 would provide an ad to advertising client 120. Application 112 could be loaded onto mobile device 110 and could be provided by various third party creators of applications. In this case, the application 112 could request the ad from an advertising server 140 directly, or perhaps from an advertising client 120, and provides statistics on the consumption of the ad back to advertising server 140 or advertising client 120. The problem with this is that application 112 could be created by any third party and thus may not be honest about the ad consumption metrics that it provides back to advertising client 120 or advertising server 140.

One solution to this would be to make each application 112 trusted. In other words, a certifying body would have to indicate that application 112 provides real metrics regarding the consumption of advertisements. Such a certifying body could, for example, be the manufacturer of the mobile device. However, this places a high burden on application developers and/or manufactures of mobile devices and further provides delays for introducing applications onto the mobile device, may dissuade developers from creating applications, and possibly limits applications that could be loaded onto the mobile device.

The present disclosure therefore provides for a trusted advertising client 120 that is adapted to communicate with untrusted applications 112.

As used herein, trusted means trusted by an advertising delivery system operator and indirectly the by ad providers and the advertisers, forming a chain of trust.

In one embodiment of the present disclosure, the trusted advertising client has the capability of assuming control of the user interface (UI) 160 on mobile device 110 in order to take the advertising functionality out of application 112 and place it within a component of trusted advertising client 120. As will be appreciated, this further allows the content consuming or creating application 112 to focus on its core functionality without requiring the processing of advertisements by merely providing application 112 with the ability to request advertisements. Taking over control of the UI can be done, for example, though a processor on the mobile device, where the processor provides control over the UI to advertising client 120.

In one embodiment, some applications such as application 114 may be trusted themselves, allowing the advertisement handling to be performed by the application.

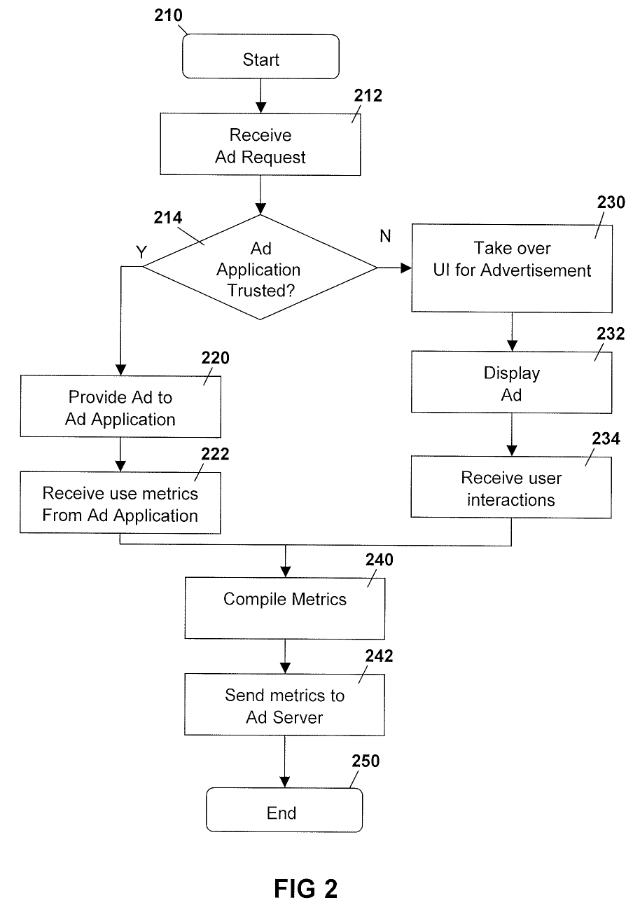

Reference is now made to FIG. 2. FIG. 2 shows a flow diagram of a process on an advertising client such as advertising client 120 from FIG. 1. The process starts at block 210 and proceeds to block 212 in which the advertising client receives a request for an advertisement from an application. The application could be application 112 from FIG. 1.

The process next proceeds to block 214 in which an optional check is made to see whether the ad application is trusted. If yes, then the process proceeds to block 220 and the advertisement is provided to the advertisement application or in some embodiments the trusted application can access the ad itself. The process then proceeds to block 222 in which use metrics are received back from the application.

From block 214 if the ad application requesting the ad is not trusted the process proceeds to block 230 in which the user interface required for the advertisement is taken over by the advertising client. Thus, for a visual display the display portion that will be utilized to show the ad is taken over by the advertising client. For an auditory user interface the speakers can be taken over to play an auditory ad. In other cases user interface may include other sensory aspects that can be taken over by the advertising client.

The process then proceeds to block 232 in which the advertisement is “displayed”. As indicated above, the displaying of an ad could be on a visual interface or alternatively could be played on the auditory portion of the user interface or provided on some sort of other user interface to a user.

The process then proceeds to block 234 in which user interactions are received regarding the advertisement.

As will be appreciated by those skilled in the art, the user interactions received in block 234 could be as simple as an indication that the ad was displayed, played on audio, among others. User interactions could also be more sophisticated interactions such as the user clicking through an advertisement or interacting with the advertisement in other ways.

Interaction models could be selected from the following non exhaustive list:
a. Click to contact (e.g.: make calls, send MMS, SMS, Email etc.);
b. Click to ask to be contacted (e.g.: receive calls, MMS, SMS, Email etc.);
c. Click to locate: the User obtains more information about the advertiser based on the location (e.g.: advertiser's shops near its location);
d. Click to enter branded Mobile Web site: the User is redirected to the Advertiser's web-site (e.g.: to fill out some forms, to get more information, etc);
e. Click to receive coupon: the User receives a discount coupon that might be stored in their device;
f. Click-to-buy: the User buys the Advertiser products;
g. Click to download content: the User receives Advertiser's related content (e.g.: ringtone, brochure, video, etc);
h. Click to forward content advertisements: the User forwards the ad directly or through Service Provider to another User;
i. Forwarding Ad;
j. Sending notification;
k. Click to request: the User requests some action from the Advertiser with some parameters associated if needed (e.g.: opt in for winning prizes, order brochure by supplying postal or email addresses, etc);
l. Click-to-discard: the User communicates to the Service Provider that the advertisement is not of his/her interest (e.g.: he/she refuses a discount coupon); or
m. Click to save or bookmark an ad.

Thus the above illustrates various metrics that can be measured and reported.

From blocks 222 or 234 the process proceeds to block 240 in which the advertising client compiles the metrics that it has received or recorded.

The process then proceeds to block 242 in which the metrics are sent to the advertising server and the process proceeds to block 250 and ends. As will be appreciated, the sending of metrics in block 242 could be done immediately, after a predetermined number of metrics have been received, periodically, among others. The present disclosure is not meant to be limited to any particular configuration for sending metrics to an advertising server.

In one embodiment a trusted application 114 could further require the advertising client 120 to assume control of the advertisements, thus proceeding through blocks 230, 232 and 234 for the trusted application.

Control over the user interface, with regard to an application, is determined by information that is exchanged over the application program interface in the advertising client and the advertising application. This could be as simple as, for example, indicating that a certain portion of a display should have an advertisement or a certain audio clip should be preceded by an advertisement audio clip, or could be more complicated, such as having a more interactive environment in which an advertisement could be placed on, for example, a three dimensional object within a game or the ad could be moving within the game.

Email Application

The above will be illustrated with reference to various applications. In one case, application 112 is an email application. The application is enabled to receive advertisements and display the advertisements along with emails. In this case, the advertising client 120 performs the actual display of the advertisements.

For example, when an email is opened the application could send a message to the advertising client 120 that an advertisement is required at position x, y on the display. Various constraints could also introduced including that the ad should be no bigger then a certain size or have certain dimensions. Other information could include context information about the content of the email in order to provide more targeted advertisement. Other examples would be apparent to those skilled in the art.

In this case, the application 112 continues to perform as it normally would on the screen by displaying the content of the email to the user. However, the other portion of the user interface is taken over by advertising client 120 and an ad is displayed on that portion of the display. The ad could be retrieved from a memory 130 or could be received from an advertising server 140.

Any interaction with the ad would be recorded by the advertising client 120. For example, if the email is talking about going out for lunch, a targeted advertisement could be placed in the email to provide a local restaurant. If the user clicks on the ad for the local restaurant this could be recorded by the advertising client 120 and statistics regarding this could be provided to the ad content provider 150 or 155.

Video Player

In another embodiment, the application could be a media player that displays videos and provides audio to a user. In this case, the ad enabled media player could indicate to the advertising client 120 that an advertisement can be inserted at the beginning of a video clip or at a certain time within the video clip. Again, for targeted advertisement, the general content of the video clip could be provided to the advertising client 120. Further, limitations such as the maximum length of a clip that is permissible could be provided to the advertising client 120. Other information or restrictions would be apparent to those skilled in the art having regard to the present disclosure.

Upon receipt of the request by the media player application, the advertising client 120 retrieves an appropriate ad and takes over the audio and video portions of the device to display the ad, after which control is returned to the media player. In other embodiments the ad could merely be text that is inserted onto the video and thus only the portion of the screen that text is displayed on is taken over by the advertising client 120. Again, other examples would be known to those in the art.

Video Game

In a further example, an advertisement could be inserted into a video game. For example, an advertisement could be displayed on a virtual billboard that a car may pass in a driving game. In this case, the API between the ad application and the advertising client could provide for more complex displaying of advertisements such as skewing the advertisement to provide for a three dimensional environment, providing motion of the ad within the game itself among others.

In alternative embodiments, the ad could be wrapped around three dimensional objects within the game such as around a lamppost, or placed on a textured surface, and thus the API would need to include information about the object around which the ad is being placed and other such information.

In other embodiments, a user may interact with an actual advertising object within the game. Thus, a character in the game may be able to walk up to a table and pick up a bottle of a branded soft drink. In this case, the API would need to include information about displaying the branded soft drink on the table but it would also need to include the ability for the advertising client 120 to know when such an interaction occurs.

The above are merely examples, and the information flow that passes between an application and an advertising client 120 could be tailored based on the particular requirements for displaying the ad and for generating metrics regarding the consumption of the ad. Thus mouse or scroll wheel clicks could go to the application unless the clicks get close to an advertisement, at which point the trusted advertising client 120 could receive the click and process it to determine whether the click is relevant for the ad. Such interaction might require the interaction of the advertising client 120 to be able to return information to the application 112 and allow the application 112 to run smoothly. Other options would be known to those in the art.

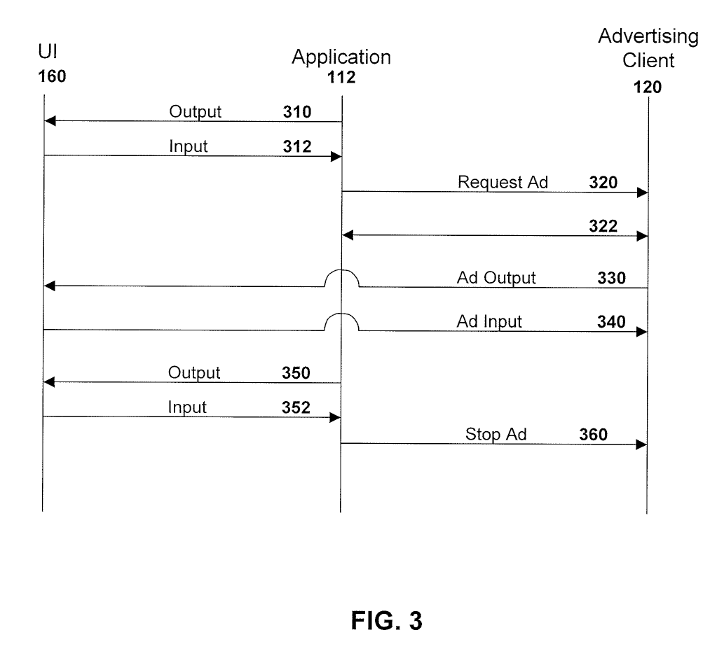

Reference is now made to FIG. 3. FIG. 3 shows a data flow diagram between a user interface 160, and advertising application 112 and an advertising client 120. As will be appreciated by those in the art, FIG. 3 is a generalization of the above embodiments. The flow diagram shows that ad application 112 communicates with UI 160 by providing outputs 310 and receiving inputs 312. Outputs 310 could be directed to any output for a user interface including, but not limited to, a display, a speaker, a vibration motor, or other similar outputs. Input 312 could be any input to a user interface including, but not limited to: a keystroke, a mouse click, a mouse movement, a scroll wheel movement, a scroll wheel click, a touch screen interaction, a stylus movement, a microphone input, among others.

Outputs 310 and inputs 312 could continue as ad application 112 has control over UI 160.

Ad application 112 at some point decides that an advertisement is needed and therefore sends a request ad message 320 to advertising client 120. Message 320 could, as described above, include various parameters including the type of ad, the size of the ad, the location of the ad, the point that the ad should be inserted, the duration of the ad, among others. Further, the request ad message 320 could be supplemented by communications between ad application 112 and advertising client 120 as shown by arrow 322.

Based on the request ad message 320 and any supplemental ad messages 322, advertising client 120 takes control over the UI or a portion thereof as shown by arrow 330 to provide the ad to the UI 160. Further, interactions with the UI or a portion thereof by a user are provided back to advertising client 120 as shown by arrow 340.

While the ad is being displayed and user interactions are being recorded, ad application 112 can still maintain control over a portion of UI 160 in some embodiments. This is shown by output 350 and input 352.

In one embodiment, ad application 112 has the option of stopping the display of the advertisement by requesting this from advertising client 120. This is shown by the stop advertisement message 360.

As will be appreciated by those skilled in the art, the above references a user interface on a mobile device for an advertising client 120. However, the same is equally applicable to a wired environment. For example, a user interface on a desktop or laptop computer connected by an Ethernet cable to the Internet could be controlled in the same way. In other words, a trusted ad application 112 is added to the desktop or laptop computer and, thereafter, untrusted advertising applications could utilize the trusted advertising client 120 to provide ads on the UI 160. With a wired connection the advertising client 120 may prefer to get advertisements in real time from an advertising server 140 (shown in FIG. 1). In other embodiments, advertising client 120 could use storage on the desktop or laptop computer.

In a further embodiment, it may be possible to remotely control user interface 160. In this case, advertising client 120 does not need to be located on the device since the UI is being controlled and could be located remotely at another location within the network. Alternatively, portions of the advertising client 120 could be located on the device and other portions of it could be located at other locations in the network. Thus, the advertising client 120 could be divided with logical functions at various locations within a network.

In a wireless environment, the above could be implemented on any mobile device. One exemplary mobile device is illustrated with reference to FIG. 4.

Mobile device 400 is preferably a two-way wireless communication device having at least voice and data communication capabilities. Mobile device 400 preferably has the capability to communicate with other computer systems on the Internet. Depending on the exact functionality provided, the wireless device may be referred to as a data messaging device, a two-way pager, a wireless e-mail device, a cellular telephone with data messaging capabilities, a wireless Internet appliance, or a data communication device, as examples.

Where mobile device 400 is enabled for two-way communication, it will incorporate a communication subsystem 411, including both a receiver 412 and a transmitter 414, as well as associated components such as one or more, preferably embedded or internal, antenna elements 416 and 418, local oscillators (LOs) 413, and a processing module such as a digital signal processor (DSP) 420. As will be apparent to those skilled in the field of communications, the particular design of the communication subsystem 411 will be dependent upon the communication network in which the device is intended to operate.

Network access requirements will also vary depending upon the type of network 419. In some CDMA networks network access is associated with a subscriber or user of mobile device 400. A CDMA mobile device may require a removable user identity module (RUIM) or a subscriber identity module (SIM) card in order to operate on a CDMA network. The SIM/RUIM interface 444 is normally similar to a card-slot into which a SIM/RUIM card can be inserted and ejected like a diskette or PCMCIA card. The SIM/RUIM card can have approximately 64K of memory and hold many key configuration 451, and other information 453 such as identification, and subscriber related information.

When required network registration or activation procedures have been completed, mobile device 400 may send and receive communication signals over the network 419. As illustrated in FIG. 4, network 419 can consist of multiple base stations communicating with the mobile device. For example, in a hybrid CDMA 1× EVDO system, a CDMA base station and an EVDO base station communicate with the mobile station and the mobile device is connected to both simultaneously. The EVDO and CDMA 1× base stations use different paging slots to communicate with the mobile device.

Signals received by antenna 416 through communication network 419 are input to receiver 412, which may perform such common receiver functions as signal amplification, frequency down conversion, filtering, channel selection and the like, and in the example system shown in FIG. 4, analog to digital (A/D) conversion. A/D conversion of a received signal allows more complex communication functions such as demodulation and decoding to be performed in the DSP 420. In a similar manner, signals to be transmitted are processed, including modulation and encoding for example, by DSP 420 and input to transmitter 414 for digital to analog conversion, frequency up conversion, filtering, amplification and transmission over the communication network 419 via antenna 418. DSP 420 not only processes communication signals, but also provides for receiver and transmitter control. For example, the gains applied to communication signals in receiver 412 and transmitter 414 may be adaptively controlled through automatic gain control algorithms implemented in DSP 420.

Mobile device 400 preferably includes a microprocessor 438 which controls the overall operation of the device. Communication functions, including at least data and voice communications, are performed through communication subsystem 411. Microprocessor 438 also interacts with further device subsystems such as the display 422, flash memory 424, random access memory (RAM) 426, auxiliary input/output (I/O) subsystems 428, serial port 430, one or more keyboards or keypads 432, speaker 434, microphone 436, other communication subsystem 440 such as a short-range communications subsystem and any other device subsystems generally designated as 442. Serial port 430 could include a USB port or other port known to those in the art.

Some of the subsystems shown in FIG. 4 perform communication-related functions, whereas other subsystems may provide “resident” or on-device functions. Notably, some subsystems, such as keyboard 432 and display 422, for example, may be used for both communication-related functions, such as entering a text message for transmission over a communication network, and device-resident functions such as a calculator or task list.

Operating system software used by the microprocessor 438 is preferably stored in a persistent store such as flash memory 424, which may instead be a read-only memory (ROM) or similar storage element (not shown). Those skilled in the art will appreciate that the operating system, specific device applications, or parts thereof, may be temporarily loaded into a volatile memory such as RAM 426. Received communication signals may also be stored in RAM 426.

As shown, flash memory 424 can be segregated into different areas for both computer programs 458 and program data storage 450, 452, 454 and 456. These different storage types indicate that each program can allocate a portion of flash memory 424 for their own data storage requirements. Microprocessor 438, in addition to its operating system functions, preferably enables execution of software applications on the mobile device. A predetermined set of applications that control basic operations, including at least data and voice communication applications for example, will normally be installed on mobile device 400 during manufacturing. Other applications could be installed subsequently or dynamically.

A preferred software application may be a personal information manager (PIM) application having the ability to organize and manage data items relating to the user of the mobile device such as, but not limited to, e-mail, calendar events, voice mails, appointments, and task items. Naturally, one or more memory stores would be available on the mobile device to facilitate storage of PIM data items. Such PIM application would preferably have the ability to send and receive data items, via the wireless network 419. In a preferred embodiment, the PIM data items are seamlessly integrated, synchronized and updated, via the wireless network 419, with the mobile device user's corresponding data items stored or associated with a host computer system. Further applications may also be loaded onto the mobile device 400 through the network 419, an auxiliary I/O subsystem 428, serial port 430, short-range communications subsystem 440 or any other suitable subsystem 442, and installed by a user in the RAM 426 or preferably a non-volatile store (not shown) for execution by the microprocessor 438. Such flexibility in application installation increases the functionality of the device and may provide enhanced on-device functions, communication-related functions, or both. For example, secure communication applications may enable electronic commerce functions and other such financial transactions to be performed using the mobile device 400.

In a data communication mode, a received signal such as a text message or web page download will be processed by the communication subsystem 411 and input to the microprocessor 438, which preferably further processes the received signal for output to the display 422, or alternatively to an auxiliary I/O device 428.

A user of mobile device 400 may also compose data items such as email messages for example, using the keyboard 432, which is preferably a complete alphanumeric keyboard or telephone-type keypad, in conjunction with the display 422 and possibly an auxiliary I/O device 428. Such composed items may then be transmitted over a communication network through the communication subsystem 411.

For voice communications, overall operation of mobile device 400 is similar, except that received signals would preferably be output to a speaker 434 and signals for transmission would be generated by a microphone 436. Alternative voice or audio I/O subsystems, such as a voice message recording subsystem, may also be implemented on mobile device 400. Although voice or audio signal output is preferably accomplished primarily through the speaker 434, display 422 may also be used to provide an indication of the identity of a calling party, the duration of a voice call, or other voice call related information for example.

Serial port 430 in FIG. 4, would normally be implemented in a personal digital assistant (PDA)-type mobile device for which synchronization with a user's desktop computer (not shown) may be desirable, but is an optional device component. Such a port 430 would enable a user to set preferences through an external device or software application and would extend the capabilities of mobile device 400 by providing for information or software downloads to mobile device 400 other than through a wireless communication network. The alternate download path may for example be used to load an encryption key onto the device through a direct and thus reliable and trusted connection to thereby enable secure device communication. As will be appreciated by those skilled in the art, serial port 430 can further be used to connect the mobile device to a computer to act as a modem.

Other communications subsystems 440, such as a short-range communications subsystem, is a further optional component which may provide for communication between mobile device 400 and different systems or devices, which need not necessarily be similar devices. For example, the subsystem 440 may include an infrared device and associated circuits and components or a Bluetooth™ communication module to provide for communication with similarly enabled systems and devices.

In one embodiment, an advertising client 460 communicates with processor 438 to provide the functionality as disclosed herein.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

1. A method to avoid fake advertisement metrics from an untrusted application using a trusted advertising client comprising:
receiving an indication at the trusted advertising client from the untrusted application that an advertisement is required;
assuming control by the trusted advertising client of at least a portion of a user interface;
providing the advertisement;
receiving and compiling metrics at the trusted advertising client; and
reporting the compiled metrics.

2. The method of claim 1, wherein the compiling is based on interaction through the user interface with the advertisement.

3. The method of claim 2, wherein the interaction is selected from the group consisting of: click to contact; click to ask to be contacted; click to locate; click to enter branded Mobile Web site; click to receive coupon; click-to-buy; click to download content; click to forward content advertisements; forwarding ad; sending notification; click to request; click-to-discard; and click to save or bookmark.

4. The method of claim 1, wherein assuming control is over the entire user interface.

5. The method of claim 1, wherein the receiving the indication includes information about a desired advertisement.

6. The method of claim 5, wherein the information about the desired advertisement includes at least one factor selected from the group consisting of: a size of the desired advertisement, a screen location for the desired advertisement; an insertion point for the desired advertisement; a shape for the desired advertisement; a texture for the desired advertisement; a duration for the desired advertisement; and a three dimensional plane for the desired advertisement.

7. The method of claim 1, wherein the advertisement is retrieved from a memory location.

8. The method of claim 1, wherein the advertisement is requested from an advertisement server.

9. The method of claim 1, wherein the method is performed by an advertising client on a device.

10. The method of claim 9, wherein the device is a mobile device.

11. The method of claim 1, further comprising checking whether the application is untrusted.

12. The method of claim 11, where responsive to the checking the method further comprises providing an advertisement directly to a trusted application.

13. The method of claim 11, where responsive to the checking the method further comprises accessing an advertisement directly by a trusted application.

14. A device adapted to avoid fake advertisement metrics comprising:
a processor;
a communications subsystem;
a user interface;
at least one untrusted application running on said processor, said at least one untrusted application adapted to interact with said user interface; and
a trusted advertising client, said trusted advertising client adapted to receive a request from the untrusted application for an advertisement, assume control over at least a portion of the user interface, provide the advertisement over the user interface, and compile advertisement metrics.

15. The device of claim 14, wherein the compiling is based on interaction through the user interface with the advertisement.

16. The device of claim 15, wherein the interaction is selected from the group consisting of: click to contact; click to ask to be contacted; click to locate; click to enter branded Mobile Web site; click to receive coupon; click-to-buy; click to download content; click to forward content advertisements; forwarding ad; sending notification; click to request; click-to-discard; and click to save or bookmark.

17. The device of claim 14, wherein assuming control is over the entire user interface.

18. The device of claim 14, wherein the indication includes information about a desired advertisement.

19. The device of claim 18, wherein the information about the desired advertisement includes at least one factor selected from the group consisting of: a size of the desired advertisement, a screen location for the desired advertisement; an insertion point for the desired advertisement; a shape for the desired advertisement; a texture for the desired advertisement; a duration for the desired advertisement; and a three dimensional plane for the desired advertisement.

20. The device of claim 14, further comprising memory, wherein the advertisement is retrieved from a memory location.

21. The device of claim 14, wherein the advertisement is requested over the communication subsystem from an advertisement server.

22. The device of claim 14, wherein the device is a mobile device

23. The device of claim 14, wherein the user interface includes an output component selected from the group consisting of a visual display, an audio output, and a tactile output.

24. The device of claim 14, wherein the user interface includes an input component selected from the group consisting of a keyboard, a mouse, a scroll wheel, a stylus, a touch screen, and a microphone.
